(19) United States
(12) Patent Application Publication
(10) Pub. No.: US 2019/0183291 A1
(43) Pub. Date: Jun. 20, 2019

(54) Toothbrush, electric toothbrush head and dental floss box holder

(71) Applicant: Tam Thanh Nguyen, Raleigh, NC (US)

(72) Inventor: Tam Thanh Nguyen, Raleigh, NC (US)

(21) Appl. No.: 15/846,097

(22) Filed: Dec. 18, 2017

(51) Int. Cl. A47K 1/09

(52) U.S. Cl. CPC A47K 1/09; A61C 15/046

(57) ABSTRACT

Each of the tubes that house the toothbrushes and the electric toothbrush heads will have a small drainage hole at the bottom to keep the toothbrushes and toothbrush heads dry, clean and germ free.

### BACKGROUND OF THE INVENTION

The present invention is in the technical field of toothbrush, electric toothbrush head and dental floss box holder. More particularly, the present invention is in the technical field of toothbrush, electric toothbrush head and dental floss box holder.

Conventional toothbrush holders are not very functional. When toothbrushes are stored in the holder for a couple of days, the water build up and germs get stuck in it which is very dirty and unhealthy for consumers. Not only that when multiple toothbrushes are stored in the same toothbrush holder and if a child is sick, the germs can spread to another kid/person.

### SUMMARY OF THE INVENTION

The present invention is a toothbrush, electric toothbrush head and dental floss box holder. This toothbrush holder allows multiple toothbrushes to store in the same holder. Each toothbrush hole will have its own drainage. Each tube will house a toothbrush. There will be a hole at the bottom of each tube. This will allow the water from the toothbrush to flow through the drainage. It also houses electric toothbrush heads and dental floss box.

### BRIEF DESCRIPTION OF THE DRAWING

FIG. 1 is the back view of the toothbrush holder of the present invention; the 1 is the tube to house the toothbrush. The shape of the toothbrush holder is circle. The 2 will house the electric toothbrush head. The shape of the electric toothbrush holder is circle. The 3 is the placeholder for the dental floss box. The shape for the dental floss box is a rectangle. The 4 will be a circular hole the locates near the bottom in the back of the toothbrush holder that allow water inside of the toothbrush holder to evaporate.

FIG. 2 is the front view of the toothbrush of the present invention. The toothbrush holder will consist of 2 pieces.

FIG. 3 is the top piece of the toothbrush holder.

FIG. 4 is the top view of the top piece of the toothbrush holder. The 5 is the small hole at the bottom of each of the toothbrush placeholders and electric toothbrush head place holders. This small hole will allow the water from the toothbrushes to drip down into the bottom of the toothbrush holder.

FIG. 5 is the bottom view of the first piece of the toothbrush holder. The 6 is the circular tube the house the toothbrush. The 7 is the circular tube that house the electric toothbrush. The 8 is the rectangular box that house the dental floss box.

FIG. 6 is the bottom piece of the toothbrush holder. The top piece will be place on top of the bottom piece

### DETAILED DESCRIPTION OF THE INVENTION

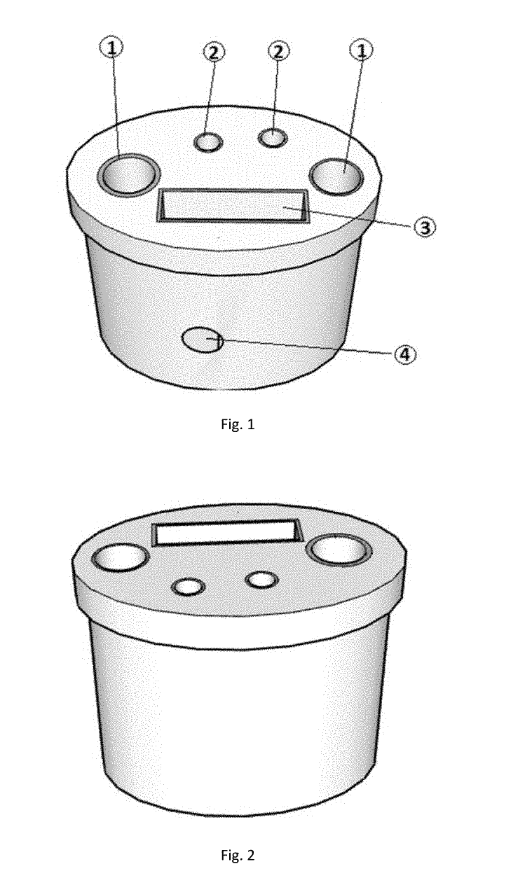

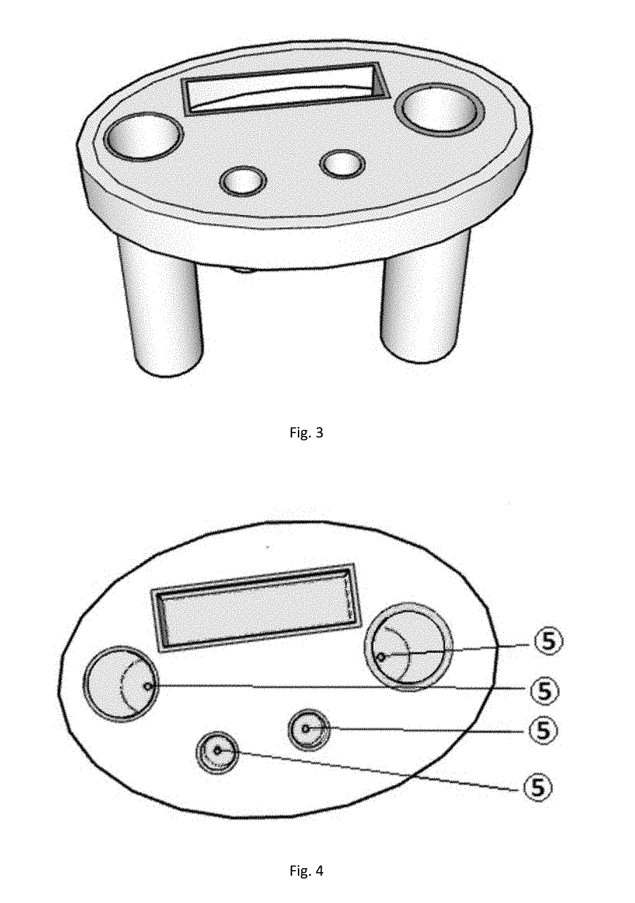

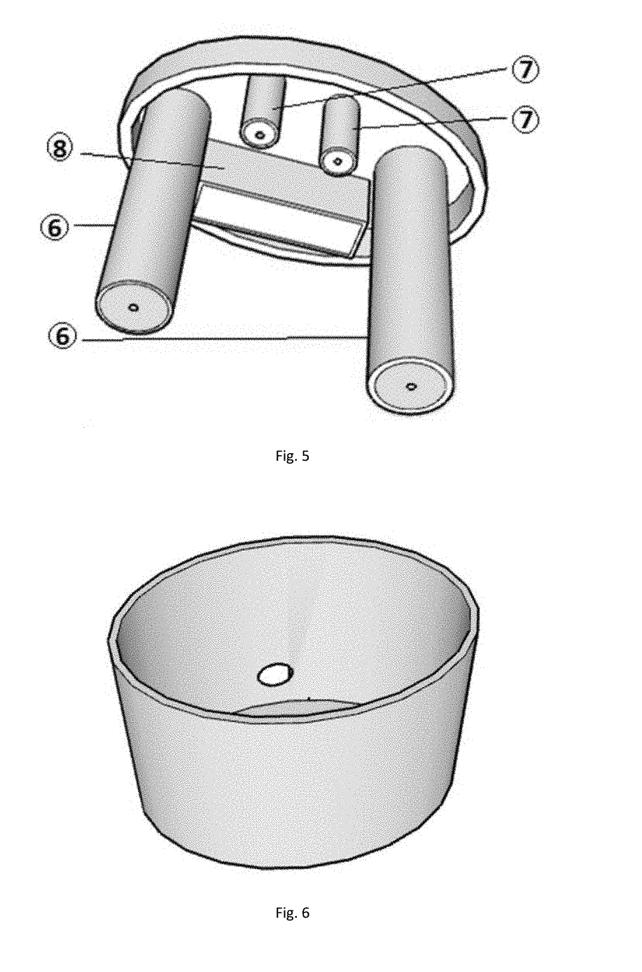

Referring now to the invention in more detail, in FIG. 1, FIG. 2, FIG. 3, FIG. 4, FIG. 5, and FIG. 6, there will be 2 tubes to house the toothbrushes and 2 smaller tubes to house electric toothbrush heads and a dental floss box holder. In FIG. 1, is the perspective view of the toothbrush holder. There will be 4 tubes; 2 bigger tubes will be used to house the toothbrushes and two smaller tubes to house the electric toothbrush heads. Each of these 4 tubes will have a small hole at the bottom that allow water from the toothbrush to drip down into the bottom of the toothbrush holder. The Rectangular box will be a placeholder 3 to house the dental floss box.

The advantages of the present invention include, without limitation, that it is preventing water to build up in the toothbrush holder. By keeping the toothbrushes dried and clean, the germs will not be accumulated. Furthermore, each of the hole will not be connected to each other. So, the germs of the toothbrush of the sick person will not spread to the toothbrush of another person. It also allows consumer to store the dental floss box. It will be very easy for consumers to clean or drain the water in the toothbrush holder. The consumer can easily take the top piece off and pull the water out of the bottom piece and wash it.

1-2. (canceled)

3. A Toothbrush holder that will keep toothbrushes dry and prevent germs from spreading from one toothbrush to another comprising two pieces; one piece will be put on top of the second piece, wherein two long tubes with drainage hole at the bottom which each will house a toothbrush, two short tubes with drainage hole at the bottom which each will house an electric toothbrush head, a rectangular box that will be used to house a dental floss box are all attached to the top piece, and a circular hole that locates near the bottom in the back of the second piece of the toothbrush holder that allows water inside of the toothbrush holder to evaporate which will prevent water from building up and prevent germs from spreading from one toothbrush to another.

4. A Toothbrush holder that will keep toothbrushes dry and prevent germs from spreading from one toothbrush to another comprising: a circular hole that locates near the bottom in the back of the toothbrush holder that allows water inside of the toothbrush holder to evaporate which will prevent water from building up and prevent germs from spreading from one toothbrush to another.
